(19) United States
(12) Patent Application Publication
(10) Pub. No.: US 2012/0075880 A1
(43) Pub. Date: Mar. 29, 2012

(54) LIGHT SOURCE UNIT OF SEMICONDUCTOR-TYPE LIGHT SOURCE OF VEHICLE LIGHTING DEVICE AND VEHICLE LIGHTING DEVICE

(75) Inventors: Masateru HAYASHI, Isehara-shi (JP); Katsuaki Nakano, Isehara-shi (JP)

(73) Assignee: ICHIKOH INDUSTRIES, LTD.

(21) Appl. No.: 13/245,219

(22) Filed: Sep. 26, 2011

(30) Foreign Application Priority Data
Sep. 28, 2010 (JP) 2010-216903

(51) Int. Cl. F21V 15/01; F21V 15/00

(52) U.S. Cl. 362/547; 362/549

(57) ABSTRACT

The conventional light source unit has problems of an increasing size and radiation. According to the present invention, a direction “D” for mounting the connector 14 at a power source side to a connector portion 13 is perpendicular or substantially perpendicular with respect to a direction O-O for mounting a light source unit 1 to the vehicle light unit 100. As a result, the present invention can decrease a depth space of the light source unit and efficiently radiated heat generated by the light emitting chips 40 to 44, resistances RS, RT, RP, diodes DS, DT, and conductors 51 to 57 from a heat radiation member 8 to an outside.

### CROSS REFERENCE TO RELATED APPLICATIONS

This application claims priority of Japanese Patent Application No. 2010-216903 filed on Sep. 28, 2010. The contents of this application are incorporated herein by reference in their entirety.

### BACKGROUND OF THE INVENTION

1. Field of the Invention

The present invention relates to a light source unit of a semiconductor-type light source of a vehicle lighting device. In addition, the present invention relates to a vehicle lighting device using a semiconductor-type light source as a light source.

2. Description of the Related Art

This type of a light source unit has been conventionally provided (e.g., Japanese Patent Application Laid-Open No. 2004-031076). Hereinafter, the conventional light source unit will be described. The conventional light source unit includes a socket casing having a mount portion, into which a light emitting diode (LED), a resistance, a diode, and a conductor that are mechanically mounted and electrically connected to an upper contact point and a lower contact point are combined. The conventional light source unit can be detachably mounted to a vehicle light unit via the mount portion of the socket casing.

However, since the conventional light source unit includes the socket casing, into which the LED, the resistance, the diode, and the conductor that are mechanically mounted and electrically connected to the upper contact point and the lower contact point are combined, the light source unit tends to increase its size. Further, since the conventional light source unit does not includes a unit for radiating heat generated by the LED, the resistance, the diode, and the conductor to an outside, it has a problem of radiating the heat from the LED, the resistance, the diode, and the conductor.

The problems to be solved by the present invention is the tendency of increasing the size of the conventional light source unit and the radiation of the heat from the LED, the resistance, the diode, and the conductor.

### SUMMARY OF THE INVENTION

A light source unit of a semiconductor-type light source for a vehicle light unit according to present invention (in claim 1), comprising:

a light source portion and a socket portion to which the light source portion is mounted, wherein

the light source portion comprises a mount member including a mounting surface and an abutment surface, a light emitting chip of a semiconductor-type light source, a control element for controlling light emitting of the light emitting chip, a wiring element for feeding power to the light emitting chip via the control element;

the light emitting chip, the control element, and the wiring element are mounted onto the mounting surface of the mount portion;

the socket portion comprises an insulation member, a heat radiation member that includes the abutment surface to which the abutment surface of the mount member is abutted and radiates heat generated by the light source portion, and a plurality of power feeding members for feeding the power to the light source portion;

the heat radiation member and the power feeding member are incorporated mutually into the insulation member in an insulation state;

a connector portion to which a connector at a power source side mechanically, detachably, electrically, continuously mounted is provided leaning against a center of the light source portion and the socket portions;

the connector portion includes a part of the insulation member and a one-end part of the power feeding member;

at least, a portion opposite to the connector portion in the heat radiation member is exposed out of the insulation member;

a direction for mounting the light source unit to the vehicle light unit is perpendicular or substantially perpendicular with respect to the mounting surface on the mount member; and

a direction for mounting the connector at the power source side to the connector portion is perpendicular or substantially perpendicular with respect to the direction for mounting the light source unit to the vehicle light unit.

Further in the present invention (in claim 2), the power feeding member is disposed at a side of the connector portion with respect to the center of the light source portion and the socket portion.

Furthermore, in the present invention (in claim 3), the connector portion is placed to be, when the light source portion is mounted to the vehicle light unit via the mount portion, at a lower side with respect to a center of the light source portion and the socket portion.

Further, in the present invention (in claim 4), at least a part of the heat radiation member exposed out of the insulation member has a fin-like shape,

a direction of the fin-like shape of the heat radiation member corresponds to or substantially corresponds to a direction in which air flows when the light source portion is mounted to the vehicle light unit via the mount portion.

Furthermore, in the present invention (in claim 5), a one-end part included in the connector portion of a plurality of power feeding members are disposed in one line perpendicularly or substantially perpendicularly with respect to the direction for mounting the light source unit to the vehicle light unit.

Further, in the present invention (in claim 6), when the light source portion is mounted to the vehicle light unit via the mount portion, on a surface other than a surface opposite to the vehicle light unit, a lock unit for locking a state for mounting the connector at the power source side is provided.

A vehicle light unit according to present invention, including a semiconductor-type light source as a light source, comprising:

a lamp housing configured to divide a lamp room, and a lamp lens;

a light source unit of a semiconductor-type for a vehicle light unit according to claims 1 to 6 that is disposed in the lamp room.

A light source unit of a semiconductor-type light source for a vehicle light unit (according to claim 1) of the present invention includes a light source portion including a light emitting chip, a control element, and a wiring element, which are mounted onto a mounting surface of a mount member, and a socket portion including a heat radiation member and a power feeding member, which are mutually incorporated into an insulation member in an insulation state. An abutment surface of the mount portion and an abutment surface of the heat radiation member abut to each other, and the light source portion is mounted to the socket portion. More specifically, the light source unit of a semiconductor-type light source for the vehicle light unit (according to claim 1) of the present invention integrally includes the light source portion including the light emitting chip, the control element, the wiring element, and the mount member, and the socket portion including the heat radiation member, the power feeding member, and the insulation member. As a result, the light source unit of a semiconductor-type light source for the vehicle light unit (according to claim 1) of the present invention can be decreased in size compared with the conventional light source unit in which the LED, the resistance, the diode, and the conductor are mechanically mounted and electrically connected to the upper contact point and the lower contact point and then mounted into a socket casing.

Particularly, according to the light source unit of a semiconductor-type light source for a vehicle light unit (according to claim 1) of the present invention, since a direction for mounting a connector at a power source side to a connector portion is perpendicular or substantially perpendicular with respect to a direction for mounting the light source unit to the vehicle light unit, its dimensions in directions (direction of a center line of the light source unit, optical axis direction thereof, and depth direction thereof) of the center line of the light source portion and the socket portion can be decreased, compared with the light source unit having a direction for mounting the connector at the power source sider to the connector portion in a straight line or substantially straight line with respect to a direction for mounting the light source unit to the vehicle light unit. In other words, the light source unit of a semiconductor-type light source for a vehicle light unit (according to claim 1) of the present invention can decrease a depth space thereof.

Further, according to the light source unit of a semiconductor-type light source for a vehicle light unit (according to claim 1) of the present invention, since the abutment surface of the mount member of the light source portion and the abutment surface of the heat radiation member of the socket portion mutually abut to each other, the heat generated by the light emitting chip, the control element, and the wiring element is conveyed to the radiation member via the mount portion, and then radiated (spread, diffused, heat radiated, heat spread, and heat diffused) from the radiation member to the outside. As a result, the light source unit of a semiconductor-type light source for a vehicle light unit (according to claim 1) of the present invention can solve the problem of radiating the heat from the light emitting chip, the control element, and the wiring element.

Particularly, according to the light source unit of a semiconductor-type light source for a vehicle light unit (according to claim 1) of the present invention, since the direction for mounting the connector at the power source sider to the connector portion is perpendicular or substantially perpendicular with respect to the direction for mounting the light source unit to the vehicle light unit, a surface (portion) where the heat radiation member is in contact with the air can be widened (increased), compared with the light source unit having a direction for mounting the connector at the power source sider to the connector portion is in a straight line or substantially straight line with respect to the direction for mounting the light source unit to the vehicle light unit. In other words, the surface (portion) of the heat radiation member where the heat radiation member is in contact with the air can be widened (increased). As a result, the light source unit of a semiconductor-type light source for a vehicle light unit (according to claim 1) of the present invention can efficiently radiate the heat generated by the light emitting chip, the control element, and the wiring element from the radiation member to an outside. Therefore, a current to be supplied to the light emitting chip can be raised (heightened, increased), and accordingly, a light flux (light intensity, brightness, luminance, and light amount) of light radiated from the light emitting chip can be raised (increased).

Further, according to the light source unit of a semiconductor-type light source for a vehicle light unit (according to claim 2) of the present invention, since the power feeding member is disposed at a side of the connector portion with respect to the center of the light source portion and the socket portion, a part of the insulation member included in the connector portion can be disposed closer to the side of the connector portion together with a one end part of the power feeding member. As a result, according to the light source unit of a semiconductor-type light source for a vehicle light unit (according to claim 1) of the present invention, since the surface (portion) of the heat radiation member exposed out of the insulation member can be further widened (increased), the heat generated by the light emitting chip, the control element, and the wiring element can be further efficiently radiated from the radiation member to the outside.

Furthermore, according to the light source unit of a semiconductor-type light source for a vehicle light unit (according to claim 3) of the present invention, since the connector portion is placed, when the light source unit is mounted to the vehicle light unit, at a lower side with respect to the center of the light source portion and the socket portion, a part of the insulation member included in the connector portion is placed at the lower side therewith together with the one end part of the power feeding member while the heat radiation member exposed out of the insulation member is placed at an upper side. As a result, the light source unit of a semiconductor-type light source for a vehicle light unit (according to claim 3) of the present invention can radiate the heat generated by the light emitting chip, the control element, and the wiring element further efficiently from the heat radiation member to the outside due to a convective flow of the air flowing from a lower side to an upper side.

Furthermore, according to the light source unit and the vehicle light unit of the present invention (according to claim 4), when the light source unit is mounted to the vehicle light unit, since a direction of a fin-like shape of the heat radiation member corresponds to or substantially corresponds to a direction in which the air flows, the heat is radiated in the direction in which the air flows along the fin-like shape of the heat radiation member, thereby further improving a heat-radiation effect. At this point, in the vehicle light unit, a rib or a space may be generally formed in at least one of a lamp housing and a body due to the mount of the lamp housing to the body of the vehicle. In this case, the air flows along the space in the rib. Therefore, in the case described above, the light source unit of a semiconductor-type light source for the vehicle light unit of the present invention (according to claim 4) is most appropriate to improve the heat radiation effect.

Moreover, according to the light source unit and the vehicle light unit of the present invention (according to claim 5), since one-end parts included in the connector portions of a plurality of power feeding members are disposed in one line perpendicularly or substantially perpendicularly with respect to the direction for mounting the light source unit to the vehicle light unit, the dimensions in the center line direction (center line direction of the light source unit, optical axis direction thereof, and depth direction thereof) of the light source portion and the socket portion, in other words, the depth space can be further decreased, compared with the light source unit in which the one-end parts included in the connector portions of the plurality of power feeding members are disposed in a direction in which the power source unit is mounted to the vehicle light unit.

Further, according to the light source unit and the vehicle light unit of the present invention (according to claim 6), since a lock unit for locking a state of mounting the connector at the power source side is provided on the surfaces other than the surface opposite to the vehicle light unit of the connector portion when the light source unit is mounted to the vehicle light unit, the dimensions in the center line direction (center line direction of the light source unit, optical axis direction thereof, and depth direction thereof) of the light source portion and the socket portion, in other words, the depth space can be further decreased, compared with the light source unit in which the lock unit is provided for locking the state of mounting the connector at the power source side on the surface of the connector portion opposite to the vehicle light unit when the light source unit 1 is mounted to the vehicle light unit 100.

Further, the vehicle light unit (according to claim 7) of the present invention can reach the similar effect to that light source unit of a semiconductor-type light source for a vehicle light unit according to any one of claims 1 to 6 by means of solving the foregoing problems.

### BRIEF DESCRIPTION OF THE DRAWINGS

FIG. 1 is a front elevation view showing the light source unit of a semiconductor-type light source for vehicle light unit according to a exemplary embodiment 1 of the present invention.

FIG. 2 is a rear elevation view showing a light source unit according to the exemplary embodiment 1 of the present invention.

FIGS. 3A, 3B are cross sectional views taken along the line shown in FIG. 1 according to the exemplary embodiment 1 of the present invention.

FIG. 4 is a cross sectional view taken along the line IV-IV shown in FIG. 2 according to the exemplary embodiment 1 of the present invention.

FIG. 5 is an exploded view of an insulation member, a heat radiation member, and a power feeding member of a light source portion and a socket portion of a light source unit according to the exemplary embodiment 1 of the present invention.

FIG. 6 is a front elevation view showing a mounting face of a mount member (board) of a light source portion according to the exemplary embodiment 1 of the present invention.

FIG. 7 is an electric circuit diagram showing a driving circuit of a semiconductor-type light source in a light source unit according to the exemplary embodiment 1 of the present invention.

FIG. 8 is a longitudinal cross sectional view (vertical cross sectional view) showing a state in which the light source unit is incorporated into a vehicle light unit, in other words, a longitudinal cross sectional view (vertical cross sectional view) showing a vehicle light unit according to the exemplary embodiment 1 of the present invention.

FIG. 9 is a front elevation view of a mount member (board) of a light source portion of a light source unit of a semiconductor-type light source for a vehicle light unit according to a exemplary embodiment 2 of the present invention.

FIG. 10 is an electric circuit diagram showing a driving circuit of a semiconductor-type light source included in a light source unit according to the exemplary embodiment 2 of the present invention.

### DESCRIPTION OF THE PREFERRED EMBODIMENTS

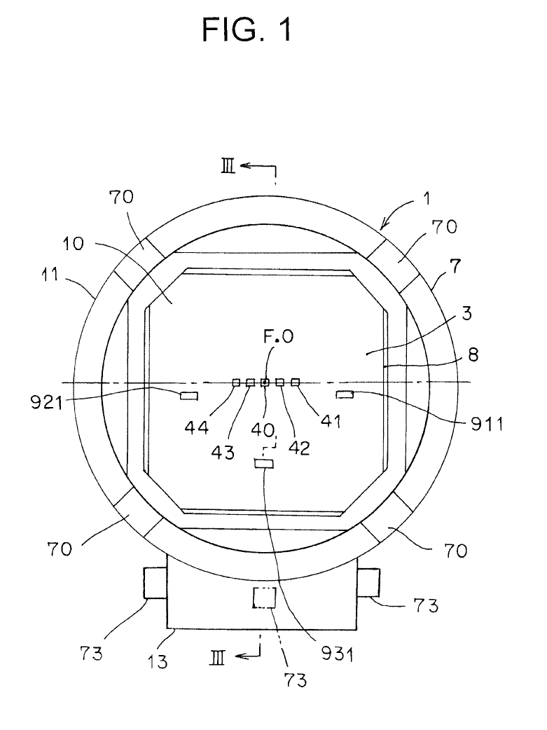

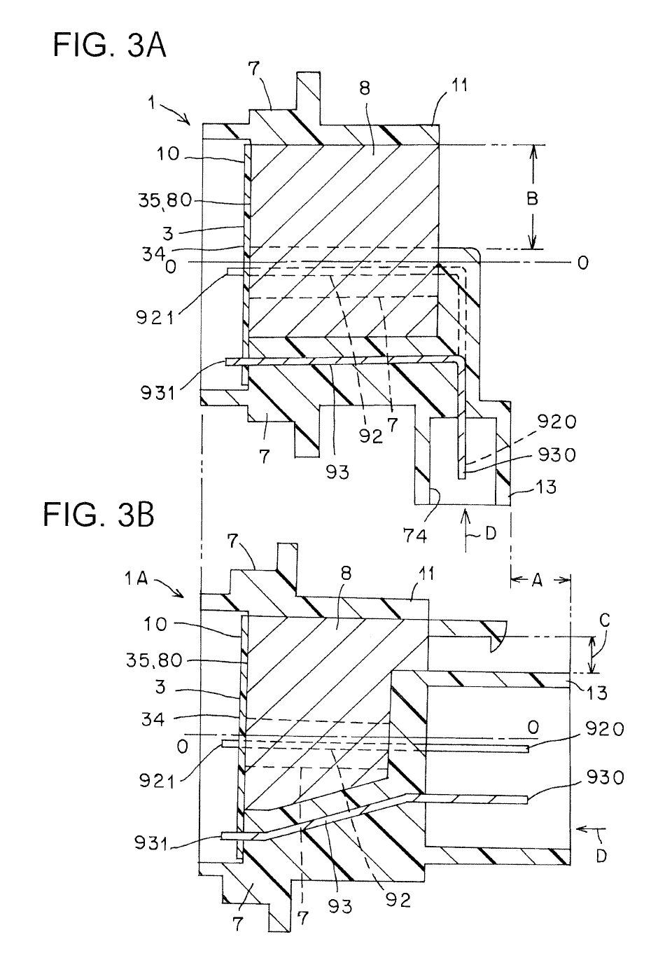

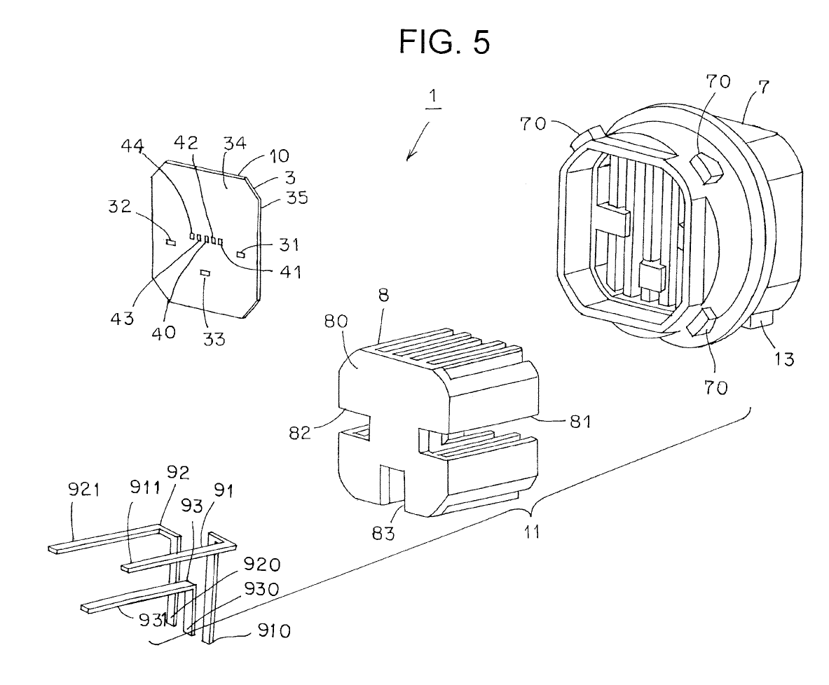

Hereinafter, with reference to the drawings, two examples of exemplary embodiments of a light source unit of a semiconductor-type light source for a vehicle light unit according to the present invention and two examples of exemplary embodiments of a vehicle light unit according to the present invention will be described in detail. The exemplary embodiment 1 is not intended to limit the present invention. A control element and a wiring element are not included in FIGS. 1, 3A, 3B to 5. Further, FIG. 3A is a cross sectional view of the light source unit of the present invention. FIG. 3B is a cross sectional view of the light source unit in which a direction for mounting a connector to a connector portion at a power source side is in a straight line or substantially straight line with respect to a direction for mounting the light source unit to the vehicle light unit.

### Exemplary Embodiment 1

FIGS. 1 to 8 show a light source unit of a semiconductor-type light source for a vehicle light unit according to the exemplary embodiment 1 of the present invention and a vehicle light unit according to the exemplary embodiment 1 of the present invention.

(Description of Configuration)

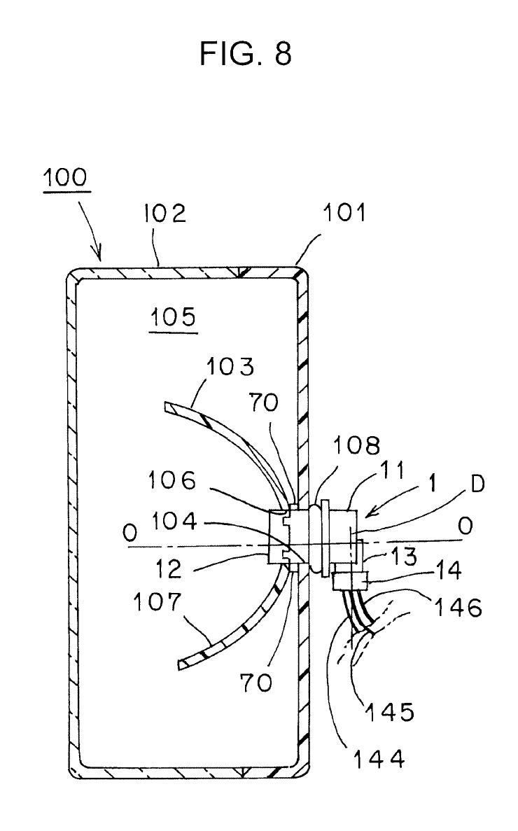

Hereinafter, a description will be given with respect to a configuration of a light source unit of a semiconductor-type light source of a vehicle lighting device, in the exemplary embodiment 1, and the vehicle lighting device in the exemplary embodiment 1. In FIG. 8, reference numeral 100 designates the vehicle lighting device in the exemplary embodiment 1.

(Description of Vehicle Lighting Device 100)

The vehicle lighting device 100 is a single-lamp type tail/stop lamp in this example. That is, the vehicle lighting device 100 uses a tail lamp function as a first ramp function and a stop lamp function as a second lamp in one combination by means of a single lamp (one lamp or one lighting device). The vehicle lighting device 100 is provided in a respective one of the left and right at a rear part of a vehicle (not shown). The vehicle lighting device 100 may be combined with another lamp function (for example, a backup lamp function or a turn signal lamp function), although not shown, to thereby constitute a rear combination lamp.

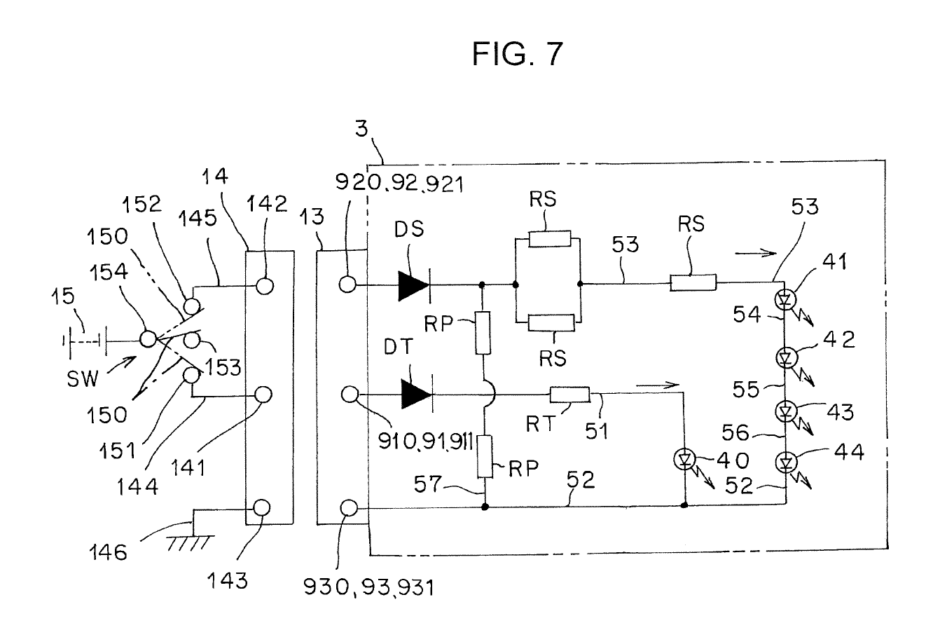

The vehicle lighting device 100, as shown in FIG. 8, is provided with: a lamp housing 101, a lamp lens 102; a reflector 103; a light source unit using a semiconductor-type light source as a light source, i.e., a light source unit 1 of the semiconductor-type light source of the vehicle lighting device, in the exemplary embodiment; and a drive circuit (shown, FIG. 7) of the semiconductor-type light source of the light source unit 1.

The lamp housing 101 is comprised of an optically opaque member, for example (a resin member, for example). The lamp housing 101 is formed in a hollow shape that opens at one side and that is closed at the other side. A through hole 104 is provided in a closed portion of the lamp housing 101.

The lamp lens 102 is comprised of an optically transmissible member, for example (a transparent resin member or a glass member, for example). The lamp lens 102 is formed in a hollow shape that opens at one side and that is closed at the other side. A circumferential edge part of an opening portion of the lamp lens 102 and a circumferential edge part of an opening portion of the lamp housing 101 are fixed to each other with water tightness. A lamp room 105 is partitioned by means of the lamp housing 101 and the lamp lens 102.

The reflector 103 is a light distribution control portion that controls optical distribution of light that is radiated from the light source unit 1, and has a focal point F. The reflector 103 is disposed in the lamp room 105 and is fixed to the lamp housing 101 or the like. The reflector 103 is comprised of an optically opaque member, for example (a resin member or a metal member, for example). The reflector 103 is formed in a hollow shape that opens at one side and that is closed at the other side. In a closed portion of the reflector 103, a through hole 106 is provided so as to communicate with the through hole 104 of the lamp housing 101. A reflection surface 107 is provided on an internal face of the reflector 103. Although the reflector 103 is made of a member that is independent of the lamp housing 101, this reflector may be integrated with the lamp housing. In this case, a reflector function is provided while a reflection surface is provided in a part of the lamp housing. The through hole 104 of the lamp housing 101 is formed in a circular shape. At an edge of the through hole 104, a plurality of recessed portions (not shown) and a plurality of stopper portions (not shown) are provided at substantially equal intervals.

(Description of Light Source Unit 1)

The light source unit 1, as shown in FIG. 1 to FIG. 6, is provided with a light source portion 10, a socket portion 11, a cover portion 12, and a connecting member 17. The light source portion 10 and the cover portion 12 are mounted at one end part (an upper end part) of the socket portion 11. The light source portion 10 is covered with the cover portion 12.

The light source unit 1, as shown in FIG. 8, is mounted on the vehicle lighting device 100. That is, the socket portion 11 is removably mounted on the lamp housing 101 via a packing (an O-ring) 108. The light source portion 10 and the cover portion 12 are disposed in the lamp room 105 through the through hole 104 of the lamp housing 101 and the trough hole 106 of the reflector 103, and are disposed on the side of the reflection surface 107 of the reflector 103.

(Description of Light Source Portion 10)

The light source portion 10, as shown in FIG. 1 to FIG. 6, is provided with: a board 3 that serves as a mount member; a plurality of, in this example, five light emitting chips 40, 41, 42, 43, and 44 of the semiconductor-type light source; resistors RS, RT, RP and diodes DS and DT, each of which serves as a control element; and conductors (patterns or conductor patterns) 51 to 57 each of which serves as a wiring element.

(Description of Board 3)

The board 3 is made of ceramics in this example. The board 3, as shown in FIG. 1, FIG. 3 to FIG. 6 is formed in a substantially octagonal plate shape as seen from a plan (top) view. Through holes 31, 32, and 33 through which power feeding members 91, 92, and 93 of the socket portion 11 are to be inserted are respectively provided at substantial centers of three edges (a right edge, a left edge, and a lower edge) of the board 3. A flat mounting surface 34 serving as a mounting surface is provided on one face (a top face) of the board 3. A flat abutment surface 35 is provided on the other face (a bottom face) of the board 3. A high reflection surface 30 subjected to high reflection coating or high reflection vapor deposition or the like may be further provided on the mounting surface 34 of the board 3 made of ceramics that is a high reflection member.

On the mounting surface 34 of the board, the five light emitting chips 40 to 44 and the resistance RS, RT, RP, the diodes DS, DT, and the conductors 51 to 57 are mounted (i.e., provided by mounting, printing, burning, depositing, soldering, laser wielding, and tightening). The board 3 is mechanically fixed to the heat radiation member 8 of the socket portion 11 by a fixing member (not shown). As the fixing member, the power feeding members 91, 92, 93 of the socket portion 11, a connecting member (refer to Japanese Patent Application Laid-Open No. 2010-124621), or a washer and a plate (refer to Japanese Patent Application Laid-Open No. 2010-160133) are used.

(Description of Light Emitting Chips 40 to 44)

The semiconductor-type light source is a light emitting semiconductor-type light source (light emitting diode (LED) according to the exemplary embodiment 1) such as LED and electroluminescence (EL)(organic EL), and includes the five light emitting chips 40 to 44. More specifically, the semiconductor-type light source includes one light emitting chip 40 having a tale lamp function (hereinafter, simply referred to as a “first lamp function”) as a first lamp function, and four light emitting chips 41, 42, 43, 44 having a strap lamp function (hereinafter, simply referred to as a “second lamp function”) as a second lamp function. The one light emitting chip 40 having the first lamp function, and the four light emitting chips 41 to 44 having the second lamp function include a bear chip of a flip chip type. The five light emitting chips 40 to 44 may include a bear chip of a wire bonding type or a bear chip of a reflection type in addition to a bear chip of a flip chip type.

The light emitting chips 40 to 44, as shown in FIGS. 1 and 5 to 7, include semiconductor chips (light source chips) in a minute rectangular shape (square or rectangular) viewed from a front. At two corner portions on diagonal lines on one surface (rear surface) of each of the light emitting chips 40 to 44, an electrode (not shown) is provided. A surface of each of the light emitting chips 40 to 44 is mounted onto the mounting surface 34 of the board 3, and then the electrode of each of the light emitting chips 40 to 44 is electrically connected to the conductors 51 to 57 of the board 3. The five light emitting chips 40 to 44 radiate the light from a front surface and a side surface other than the face onto which the board 3 is mounted.

The five light emitting chips 40 to 44, as shown in FIG. 1, are disposed close to a focal point “F” and a center “O” of the light source unit 1 in a line in a right-left direction so as to emit the light in the substantially same manner as that by arc discharge from a discharge light bulb (high intensity discharge (HID) lamp). The center “O” of the light source unit 1 corresponds to a center “O” of the light source portion 10, a center “O” of the socket portion 11, a center “O” of the board 3, a center “O” of the heat radiation member 8 described below, a center of mounting rotation of the light source unit 1, a center line O-O of the light source unit 1, and the optical axis O-O of the light source unit 1.

The one light emitting chip 40 having the first lamp function is placed closely between the two right light emitting chips 41, 42 having the second lamp function and the two left light emitting chips 43, 44 having the second lamp function. A small current is supplied to the one light emitting chip 40 having the first lamp function and a large current is supplied to the four light emitting chips 41 to 44 having the second lamp function. The four light emitting chips 41 to 44 having the second lamp function are connected to one another in series in a forward direction.

(Description of Resistors RS, RT, RP)

The resistors RS, RT, RP are made of thin-film resistors or thick-film resistors, for example. The resistors RS, RT are adjustment resistors for obtaining a predetermined value of a drive current. That is, the value of the drive current that is to be supplied to the light emitting chips 40 to 44 varies depending on a distortion of Vf (voltage characteristics in forward direction) of the light emitting chips 40 to 44, and a distortion occurs in brightness (luminous flux, luminance, luminous intensity, or intensity of illumination) of the light emitting chips 40 to 44. Thus, a value of the resistors RS, RT is adjusted (trimmed) and then the value of the drive current that is to be supplied to the light emitting chips 40 to 44 are set to be substantially constant at a predetermined value, whereby a distortion of the brightness (luminous flux, luminance, luminous intensity, or intensity of illumination) of the light emitting chips 40 to 44 can be adjusted (absorbed). Alternatively, while brightness (luminous flux, luminance, luminous intensity, or intensity of illumination) of the light emitting chips 40 to 44 is directly monitored, the value of the resistors can be trimmed and adjusted so that the brightness (luminous flux, luminance, luminous intensity, or intensity of illumination) of the light emitting chips 40 to 44 becomes constant. The trimming is cutting part or all of the resistors RS, RT by means of laser beams, for example, and then, adjusting an (open) resistor value. The resistor value is increased by means of opening and tripping.

The resistor RP is pull-down resistors for detecting a wire disconnection of the four light emitting chips 41 to 44 in the second group, which serves as light sources of the stop lamp. The resistors RP is connected in series between a rear stage (a cathode side) of the diode DS having the stop lamp function and the power feeding member 93 on a ground side.

There are respectively disposed: the three resistor RT that are connected in series to one light emitting chip 40 having the first lamp function; the seven resistor RS that are connected in series to the four light emitting chips 41 to 44 having the second lamp function; and the two resistor RP that are connected in series to a rear stage of the diode DS having the stop lamp function, the number of dispositions may be varied depending on a resistor capacity and a variable width of a resistor to be adjusted. That is, the number of the resistors RS, RT, RP are not limited.

The resistance RS having a large amount of heat generation of the stop lamp function for supplying the large current is placed to be, when the light source unit 1 is mounted to the vehicle light unit 100 (refer to FIG. 8), at an upper position than the five light emitting chips 40 to 44. This is because, by using a nature of the heat of rising, the heat generated by the resistance RS can be discharged to the upper side without giving an impact on the five light emitting chips 40 to 44.

(Description of Diodes DS, DT)

The diodes DS and DT are made of diodes such as bear chip diodes or SMD diodes, for example. The diode DT that is connected in series to one light emitting chip 40 having the first lamp function and the resistors RT and the diode DS that is connected in series to the four light emitting chips 41 to 44 having the second lamp function and the resistors RS are diodes of an incorrect connection preventing function and a pulse noise protecting function from an opposite direction.

(Description of Conductors 51 to 57)

The conductors 51 to 57 are made of wires such as thin-film wires or thick-film wires of an electrically conductive member, for example. The conductors 51 to 56, the wire lines 61 to 65, and the bonding portions 610 to 650, each of which serves as a wiring element, are electrically fed to the light emitting chips 40 to 44 via the resistors RS, RT and RP and the diodes DS, and DT, each of which serves as a control element.

(Description of layout of light emitting chips 40 to 44, resistors RS, RT, RP, diodes DS and DT, conductors 51 to 57, and description of drive circuit)

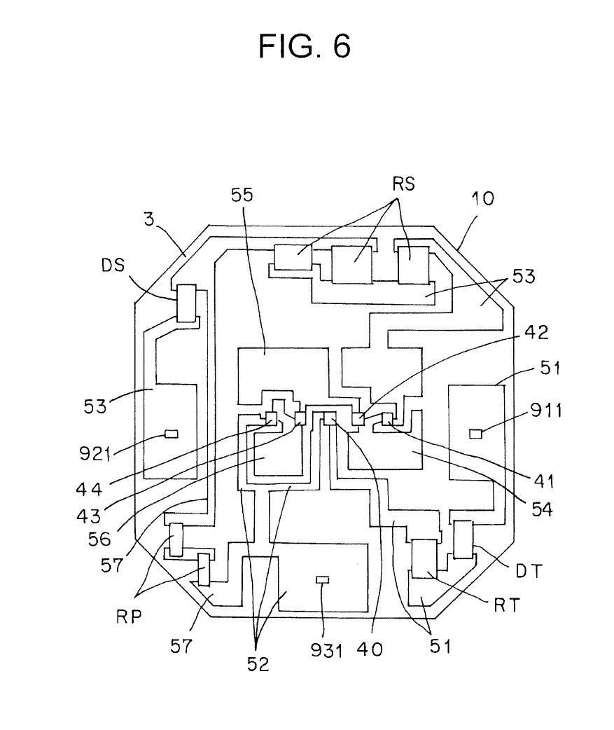

The five light emitting chips 40 to 44; the twelve resistors R1 to R12; the two diodes D1 and D2; the conductors 51 to 57 are disposed and connected to each other as shown in a layout view of electric components of FIG. 7, and layout view of FIG. 6.

The light emitting chip 40 having the first lamp function, the resistance RT, and the diode DT are connected to the first conductor 51 in series. The light emitting chip 40 having the first lamp function and the light emitting chip 44 having the second lamp function are each connected to the second conductor 52. The light emitting chip 41 having the second lamp function, the resistance RT, and the diode DT are connected to the third conductor 53 in series. The light emitting chip 42 having the second lamp function is connected to the fourth conductor 54. The light emitting chip 43 having the second lamp function is connected to the fifth conductor 55. The light emitting chip 44 having the second lamp function is connected to the sixth conductor 56. The resistance RT is connected to the seventh conductor 57. The seventh conductor 57 is connected to a latter part (cathode) side of the diode (DS) of the third conductor 53 and the second conductor 52.

(Description of Socket Portion 11)

The socket portion 11, as shown in FIG. 1 to FIG. 5 and FIG. 8, is provided with an insulation member 7, a heat radiation member 8, and three power feeding members 91, 92, and 93. The heat radiation member 8 having its thermal conductivity and electrical conductivity and the power feeding members 91 to 93 having their electrical conductivities are integrally incorporated in the insulation member 7 having its insulation property in a state in which they are insulated from each other.

The socket portion 11 is made of an integrated structure with the insulation member 7, the heat radiation member 8, and the power feeding members 91 to 93. For example, the insulation member 7, the heat radiation member 8, and the power feeding members 91 to 93 are structured to be integrally constructed by means of insert molding (integral molding). Alternatively, the insulation member 7 and the power feeding members 91 to 93 are integrally constructed by means of insert molding (integral molding), and the heat radiation member 8 is structured to be integrally mounted on the insulation member 7 and the power feeding members 91 to 93. Alternatively, the power feeding members 91 to 93 are integrally assembled with the insulation member 7, and the heat radiation member 8 is structured to be integrally mounted on the insulation member 7 and the power feeding members 91 to 93.

(Description of Insulation Member 7)

At the insulation member 7, a mount portion is provided for removably or fixedly mounting the light source unit 1 on the vehicle lighting device 100. The insulation member 7 is made of an insulation resin member, for example. The insulation member 7 is formed in a substantially cylindrical shape whose outer diameter is slightly smaller than an inner diameter of the through hole 104 of the lamp housing 101. A jaw portion 71 is integrally provided at one end part (an upper end part) of the insulation member 7. At one end part (the upper end part) of the insulation member 7, a plurality of, in this example, four mount portions 70 are integrally provided to be associated with the recessed portion of the lamp housing 101.

The mount portion 70 is intended to mount the light source unit 1 on the vehicle lighting device 100. That is, a part on the side of the cover 12 of the socket portion 11 and the mount portion 70 are inserted into the through hole 104 and the recessed portion of the lamp housing 101. In this state, the socket portion 11 is rotated axially around the center O, and the mount portion 70 is abutted against the stopper portion of the lamp housing 101. At this time point, the mount portion 70 and the jaw portion 71 sandwiches from top and bottom an edge part of the through hole 104 of the lamp housing 101 via the packing 108 (refer to FIG. 8).

As a result, the socket portion 11 of the light source unit 1, as shown in FIG. 8, is removably mounted via the packing 108 on the lamp housing 101 of the vehicle lighting device 100. At this time point, as shown in FIG. 8, a portion that is protrusive from the lamp housing 101 to the outside, of the socket portion 11, (a portion that is lower than the lamp housing 101 in FIG. 8), is greater in size than a portion that is housed in the lamp room 105, of the socket portion 11 (a portion that is upper than the lamp housing 101 in FIG. 8).

By the mount portion 70 of the socket portion 11, the light source unit can be detachably mounted to the vehicle light unit 100. In other words, the light source unit 1 can be replaced with the vehicle light unit 100. The light source unit 1 can be fixedly mounted to the vehicle light unit 100.

(Description of Connector Portion 13)

The socket portion 11 is integrally provided with the connector portion 13 at the light source side. The connector portion 13 mechanically, detachably, electrically, continuously mounts the connector 14 at the power source side.

The connector portion 13 includes a part of the insulation member 7 and male terminals 910, 920, 930 of the one-end parts (rear end parts) of the power feeding members 91, 92, 93. The connector portion 13 is provided leaning against the center “O” (the center “O” of the light source portion 10 and the “O” of the socket portion 11) of the light source unit 1.

More specifically, as shown in FIG. 8, the connector portion 13 is provided leaning downwardly against the center “O” (the center “O” of the light source portion 10 and the “O” of the socket portion 11) of the light source unit 1 when the light source unit 1 is mounted to the vehicle light unit 100 via the mount portion 70. As a result, the connector portion 13 is placed to be, when the light source unit 1 is mounted to the vehicle light unit 100, at a lower side of the center “O” of the light source unit 1.

As shown in FIG. 8, when the light source unit 1 is mounted to the vehicle light unit 100 via the mount portion 70, on the surface other than the surface opposite (rear surface) to the vehicle light unit 100, the lock unit 73 having a protruding shape is integrally provided. The lock unit 73 locks a mount state of the connector 14 at the side of the power source. As shown with a solid line in FIG. 1, the lock unit 73 may be provided at both of right and left side surfaces of the connector portion 13, or as shown with a double-dotted line, it may be provided at a front surface of the connector portion 13. Or, it may be provided at both of the right and left side surfaces of the connector portion 13 and at the front surface thereof.

On a bottom surface of the connector portion 13, an opening portion 74 is provided. The opening portion 74 electrically connects female terminals (female type terminals) 141, 142, 143 of the connector 14 at the power source side to the male terminals (male type terminal) 910, 920, 930 of the one-end parts of the power feeding members 91, 92, 93.

(Description of Direction O-O for Mounting Light Source Unit 1 and Direction “D” for Mounting Connector 14 at Power Source Side)

A direction O-O for mounting the light source unit 1 to the vehicle light unit 100 corresponds to a direction O-O for inserting a part of the socket portion 11 of the light source unit 1 at a side of the cover 12 and the mount portion 70 into a through hole 104 of the lamp housing 101 of the vehicle light unit 100 and the recessed portion. The direction O-O for mounting the light source unit 1 to the vehicle light unit 100 is perpendicular or substantially perpendicular with respect to the mounting surface 34 of the board 3.

A direction “D” for mounting of the connector 14 at the power source side to the connector portion 13 corresponds to a direction “D” for inserting the female terminals 141 to 143 of the connector 14 at the power source side into the opening portion 74 on a lower surface of the connector portion 13. The direction “D” for mounting the connector 14 at the power source side to the connector portion 13 is perpendicular or substantially perpendicular with respect to the direction O-O for mounting the light source unit 1 to the vehicle light unit 100. In other words, the direction O-O for mounting the light source unit 1 and the direction “D” for mounting the connector 14 at the power source side cross each other perpendicularly or substantially perpendicularly.

(Description of Heat Radiation Member 8)

The heat radiation member 8 is intended to radiate the heat that is generated at the light source portion 10 to the outside. The heat radiation member 8 is made of an aluminum die cast or a resin member having its thermal conductivity (also having its electrical conductivity). The heat radiation member 8 is formed in a flat shape at one end part (an upper end part) and is formed in a fin-like shape from its intermediate part to the other end part (a lower end part). An abutment surface 80 is provided on a top face of one end part of the heat radiation member 8. The abutment surface 35 of the board 3 is mutually abutted against the abutment surface 80 of the heat radiation member 8, and in that state, these abutment surfaces are adhesively bonded with each other by means of a thermally conductive medium (not shown). As a result, the light emitting chips 40 to 44 each are positioned to be associated with a portion at which a proximal portion of the center O of the heat radiation member 8 (the center O of the socket portion 11) is positioned via the board 3.

The them ally conductive medium is a thermally conductive adhesive agent, and is made of an adhesive agent such as an epoxy-based resin adhesive agent, a silicone-based resin adhesive agent, or an acryl-based resin adhesive agent, and is made of that of a type such as a liquid-like type, a fluid-like type, or a tape-like type. The thermally conductive medium may be a kind of thermally conductive grease in addition to the thermally conductive adhesive agent.

At a substantial center of each of three edges (a right edge, a left edge, and a lower edge) of the heat radiation member 8, cutouts 81, 82, and 83 are respectively provided to be associated with the through holes 31 to 33 of the board 3. The three power feeding members 91 to 93 are respectively disposed in the cutouts 81 to 83 of the heat radiation member 8 and the through holes 31 to 33 of the board 3. The insulation member 7 is interposed between the heat radiation member 8 and each of the power feeding members 91 to 93. The heat radiation member 8 comes into intimate contact with the insulation member 7. The power feeding members 91 to 93 come into intimate contact with the insulation member 7.

As shown in FIG. 3A, in the heat radiation member 8, at least an opposite part, in other words, an upper side part, which is the other end part (rear end part) opposite to the connector portion 13 is exposed out of the insulation member 7. In the heat radiation member 8, the part that is at least exposed out of the insulation member 7, in other words, the upper side part, which is the other end part (rear end part) has a fin-like shape. The direction of a fin-like shape of the heat radiation member 8 corresponds to or substantially corresponds to, when the light source unit 1 is mounted to the vehicle light unit 100 via the mount portion 70, the direction in which the air flows, in other words, a vertical direction (perpendicular direction).

(Description of Power Feeding Members 91 to 93)

The power feeding members 91 to 93 are intended to feed power to the light source portion 10. The power feeding members 91 to 93 are made of electrically conductive metal members, for example. One-end parts (upper end parts) of the power feeding members 91 to 93 are formed in a divergent shape, and are respectively positioned in the cutouts 81 to 83 of the heat radiation member 8 and through holes 31 to 33 of the board 3. One-end parts of the power feeding members 91 to 93 are respectively electrically connected to the wire 6 of the light source 10 via the connecting member 17.

The one-end parts (rear end parts) of the power feeding members 91 to 93 bended downwardly are disposed in the opening portion 74 of the connector portion 13 placed at the lower side of the socket portion 11 of the light source unit 1 to constitute the male terminals (male type terminals) 910 to 930 of the connector portion 13.

The other-end parts of the power feeding members 91, 92, 93 bended forwardly are placed at through holes 31, 32, 33 of the board 3 respectively, to constitute connecting portions 911, 921, 931. As shown in FIG. 6, the connecting portions 911 to 931 of the power feeding member 91 to 93 are electrically connected to the conductors 51, 52, 53 directly or via a connecting member of the fixing member or a plate. As a result, the light source portion 10 is mounted to the one-end part (front end opening portion) of the socket portion 11 in a cylindrical shape.

The one light emitting chip 40 having the first lamp function, and the four light emitting chips 41 to 44 having the second lamp function have a common ground. The common ground includes the power feeding member 92 at a ground side. The power feeding member 92 at the ground side serving as the common ground is placed at the lower side of the one light emitting chip 40 having the first lamp function and the four light emitting chips 41 to 44 having the second lamp function on the board 3.

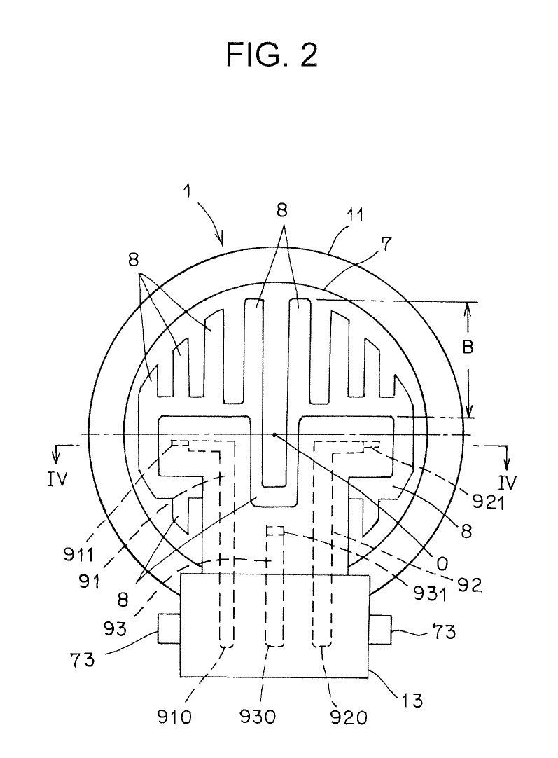

As shown in FIGS. 1, 3, the power feeding members 91 to 93 are placed at the side of the connector portion 13, in other words, the lower side with respect to the center “O” (horizontal line of the double-dotted line passing through the center “O” in FIGS. 1, 2) of the light source portion 10 and the socket portion 11 in the light source unit 1. As shown in FIGS. 2, 3, in the opening portion 74 of the connector portion 13, the male terminals 910 to 930 of the one-end parts included in the connector portion 13 of the three power feeding members 91 to 93 are disposed perpendicularly or substantially perpendicularly with respect to the direction O-O for mounting the light source unit 1 to the vehicle light unit 100 and the direction “D” for mounting the connector 14 at the power source side to the connector portion 13, in other words, in one line in the direction of right to left as shown in FIG. 2.

(Description of Connector Portion 13 and Connector 14)

At the connector 14, female terminals (female-type terminals) 141, 142, and 143 are provided for electrically connecting to or disconnecting from the male terminals 910 to 930 of the connector portion 13. The connector 14 is mounted on the connector portion 13, whereby the female terminals 141 to 143 electrically connect to the male terminals 910 to 930. In addition, the connector 14 is removed from the connector portion 13, whereby electrical connection between the male terminals 141 to 143 and the male terminals 910 to 930 is interrupted.

As shown in FIGS. 7 and 8, the first female terminal 141 and the second female terminal 142 of the connector 14 are connected to a power source (a direct current power battery) 15 via harnesses 144 and 145 and a switch SW. The third female terminal 143 of the connector 14 is earthed (grounded) via a harness 146. The connector portion 13 and the connector 14 are a connector portion and a connector of three-pin type (the three power feeding members 91 to 93, the three male terminals 910 to 930, and the three female terminals 141 to 143).

(Description of Switch SW)

The switch SW is a three-position changeover switch made of a movable contact point 150, a first fixed contact point 151, a second fixed contact point 152, a third fixed contact point 153, and a common fixed contact point 154.

When the movable contact point 150 is switched to a position of the first fixed contact point 151 (when a state indicated by the single-dotted chain line in FIG. 7 is established), a current (a drive current) is supplied to one light emitting chip 40 having the first lamp function via the diode DT having the first lamp function and the resistor RT. That is, a drive current is supplied to one light emitting chip 40 having the first lamp function via the diode DT having the first lamp function and the resistor RT.

When the movable contact point 150 is switched to a position of the second fixed contact point 152 (when a state indicated by the double-dotted chain line in FIG. 7 is established), a current (a drive current) from the power supply 15 is supplied to the four light emitting chips 41 to 44 having the second lamp function via the diode DS having the second lamp function and the resistor RS. That is, a drive current is supplied to the light emitting chips 41 to 44 having the second lamp function via the diode DS having the second lamp function and the resistor RS.

When the movable contact point 150 is switched to a position of the third fixed contact point 153 (when a state indicated by the solid line in FIG. 7 is established), power supply to the five light emitting chips 40 to 44 is interrupted.

(Description of Cover Portion 12)

The cover portion 12 is made of an optically transmissible member. At the cover portion 12, an optical control portion (not shown) such as a prism is provided for optically controlling and emitting light from the five light emitting chips 40 to 44. The cover portion 12 is an optical part or an optical member.

The cover portion 12, as shown in FIG. 8, is mounted on one end part (a one-end opening portion) of the socket portion 11 that is formed in a cylindrical shape so as to cover the light source portion 10. The cover portion 12, together with the sealing member 180, is intended to prevent the five light emitting chips 40 to 44 from an external effect, for example, from being contacted by any other foreign matter or from adhering of dust. That is, the cover portion 12 is intended to protect the five light emitting chips 40 to 44 from a disturbance. In addition to protecting the five light emitting chips 40 to 44, the cover portion 12 is also intended to protect from a disturbance: the resistors RS, RT, RP and the diodes DS and DT, each of which serves as a control element; and the conductors 51 to 57 each of which serves as a wiring element. A through hole (not shown) may be provided in the cover portion 12.

(Description of Functions)

A light source unit 1 of a semiconductor-type light source of a vehicle lighting device, in the exemplary embodiment, and a vehicle lighting device 100 in the exemplary embodiment (hereinafter, referred to as the light source unit 1 and the vehicle lighting device 100, in the exemplary embodiment) are made of the constituent elements described above. Hereinafter, functions of the light source unit and the vehicle lighting device will be described.

First, a movable contact point 150 of a switch SW is switched to a first fixed contact point 151. Then, a current (a drive current) is supplied to one light emitting chip 40 of a first lamp function via a diode DT of a first lamp function and resistor RT. As a result, one light emitting chip 40 having the first lamp function emits light.

The light that is radiated from one light emitting chip 40 having the first lamp function passes through a sealing member of the light source unit 1 and a cover portion 12, and is controlled to be optically distributed. A part of the light that is radiated from the light emitting chip 40 is reflected on the side of the cover portion 12 by means of a high reflection surface of a board 3. The light that is controlled to be optically distributed passes through a lamp lens 102 of the vehicle lighting device 100; is controlled to be optically distributed again; and then, is emitted to the outside. In this manner, the vehicle lighting device 100 emits light distribution having the first lamp function to the outside.

Next, the movable contact point 150 of the switch SW is switched to a second fixed contact point 152. Then, a current (a drive current) from power supply 15 is supplied to four light emitting chips 41 to 44 of a second lamp function via a diode DS having the second lamp function and resistors RS. As a result, the four light emitting chips 41 to 44 of the second lamp function.

The light that is radiated from the four light emitting chips 41 to 44 having the stop lamp function passes through the sealing member of the light source unit 1 and the cover member 12, and is controlled to be optically distributed. A part of the light that is radiated from the light emitting chips 41 to 44 is reflected on the side of the cover portion 12 by means of the high reflection surface of the board 3. The light that is controlled to be optically distributed passes through the lamp lens 102 of the vehicle lighting device 100; is controlled to be optically distributed again; and then, is emitted to the outside. In this manner, the vehicle lighting device 100 emits light distribution having the stop lamp function to the outside. The light distribution having the stop lamp function is bright (large in luminous flux, luminance, luminous intensity, or intensity of illumination) in comparison with that of the tail lamp.

Next, the movable contact point 150 of the switch SW is switched to a third fixed contact point 153. Then, a current (a drive current) is interrupted. As a result, one light emitting chip 40 or the four light emitting chips 41 to 44 turns or turn off the light. In this manner, the vehicle lighting device 100 turns off the light.

Then, the heat that is generated in the light emitting chips 40 to 44 of the light source portion 10; the resistors RT, RS, RP; the diodes DT and DS; and the conductors 51 to 57 transfers to the heat radiation member 8 via the board 3 and the thermally conductive medium, and then, the heat that is transferred thereto is radiated from the heat radiation member 8 to the outside. In addition, if at least one of the four light emitting chips 41 to 44 having the stop lamp function is disconnected in wiring, a system on the vehicle side can detect wire disconnection of at least one of the four light emitting chips 41 to 44 having the stop lamp function, due to a state change of pull-down resistors RP.

(Description of Advantageous Effects)

The light source unit 1 and the vehicle lighting device 100, in the exemplary embodiment, is made of the constituent elements and functions as described above. Hereinafter, advantageous effects of the light source unit and the vehicle lighting device will be described.

The light source unit 1 and the vehicle light unit 100 according to the exemplary embodiment 1 include the light emitting chips 40 to 44; the resistances RS, RT, and RP, the diodes DS, DT, each of which serves as the control elements; and the conductors 51 to 57, each of which serves as the wiring elements; all are mounted to the mounting surface 34 of the board 3 serving as the mount member. Further, the light source unit 1 and the vehicle light unit 100 include the socket portion 11 including the heat radiation member 8 and the power feeding members 91 to 93 that are mutually incorporated into the insulation member 7 in the insulation state. The abutment surface 35 of the board 3 and the abutment surface 80 of the heat radiation member 8 are abutted to each other, and then the light source portion 10 is mounted to the socket portion 11. More specifically, the light source unit 1 and the vehicle light unit 100 according to the exemplary embodiment 1 integrally includes the light source portion 10 including the light emitting chips 40 to 44, the resistances RS, RT, and RP, the diodes DS, DT, and the conductors 51 to 57, and the board 3, and the socket portion 11 including the heat radiation member 8, the power feeding members 91 to 93, and the insulation member 7. As a result, the light source unit 1 and the vehicle light unit 100 according to the exemplary embodiment 1 can be decreased in size, compared with the conventional light source unit including the LED, the resistance, the diode and the conductor, which are mechanically mounted and electrically connected to the upper contact point and the lower contact point and then incorporated into the socket casing.

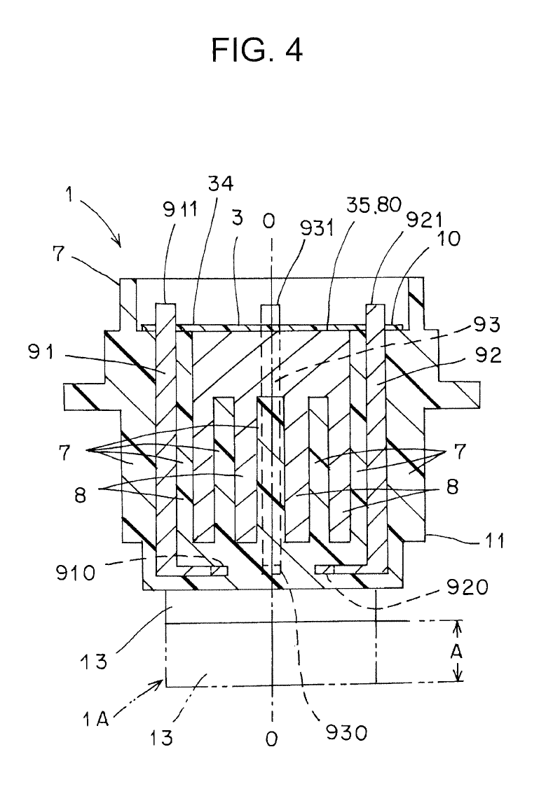

Particularly, according to the light source unit 1 and the vehicle light unit 100 of the exemplary embodiment 1, since the direction “D” for mounting the connector 14 at the power source side to the connector portion 13 is perpendicular or substantially perpendicular with respect to the direction O-O for mounting the light source unit 1 to the vehicle light unit 100, its dimensions in the center line direction O-O (center line direction O-O of the light source unit 1, optical axis direction O-O thereof, and depth direction thereof) of the light source portion 10 and the socket portion 11 can be decreased by a dimension of “A” as shown in FIGS. 3, 4, compared with the light source unit 1A (refer to FIG. 3B) having the direction “D” for mounting the connector 14 at the power source sider to the connector portion 13 in a straight line or substantially straight line with respect to the direction O-O for mounting the light source unit 1 to the vehicle light unit 100. In other words, the light source unit land the vehicle light unit 100 of the exemplary embodiment 1 can decrease a depth space thereof.

More specifically, according to the light source unit land the vehicle light unit 100 of the exemplary embodiment 1 shown in FIG. 3A, the male terminals 910 to 930 of the one-end parts of the power feeding members 91 to 93 and the connecting portions 911 to 931 of the other-end parts of the power feeding members 91 to 93 are bended in middle from each other orthogonally or substantially orthogonally between the mounting direction “D” and the center line direction O-O. On the other hand, according to the light source unit 1A shown in FIG. 3B, the male terminals 910 to 930 of the one-end parts of the power feeding members 91 to 93 and the connecting portions 911 to 931 of the other-end parts of the power feeding members 91 to 93 are disposed substantially in a straight line in the center line direction O-O. As a result, the light source unit 1 and the vehicle light unit 100 of the exemplary embodiment 1 shown in FIG. 3A can decrease the dimension of 1A in the depth direction compared with the light source unit 1A shown in FIG. 3B.

Further, according to the light source unit 1 and the vehicle light unit 100 of the exemplary embodiment 1, since the abutment surface 35 of the board of the light source portion 10 and the abutment surface 80 of the heat radiation member 8 of the socket portion 11 are abutted to each other, the heat generated by the light emitting chips 40 to 44, the resistances RS, RT, RP, the diodes DS, DT, and the conductors 51 to 57 is conveyed to the heat radiation member 8 via the board 3 and then radiated (spread, diffused, heat radiated, heat spread, and heat diffused) from the radiation member 8 to the outside. As a result, the light source unit 1 and the vehicle light unit 100 of the exemplary embodiment 1 can solve the problem of the radiation from the light emitting chips 40 to 44, the resistances RS, RT, and RP, the diodes DS, DT, and the conductors 51 to 57.

Particularly, according to the light source unit 1 and the vehicle light unit 100 of the exemplary embodiment 1, since the direction “D” for mounting the connector 14 at the power source side to the connector portion 13 is perpendicular or substantially perpendicular with respect to the direction O-O for mounting the light source unit 1 to the vehicle light unit 100, the surface (portion) of the heat radiation member 8 exposed out of the insulation member 7 can be widened (increased) by an amount of B minus C as shown by “B” in FIGS. 2, 3A and by “C” in FIG. 3B, compared with the light source unit 1A (refer to FIG. 3B) having the direction “D” for mounting the connector 14 at the power source sider to the connector portion 13 in a straight line or substantially straight line with respect to the direction O-O for mounting the light source unit 1 to the vehicle light unit 100. More specifically, the surface (portion) where the heat radiation 8 is in contact with the air can be widened (increased). As a result, since the light source unit 1 and the vehicle light unit 100 of the exemplary embodiment 1 can efficiently radiate the heat generated by the light emitting chips 40 to 44, the resistances RS, RT, RP, the diodes DS, DT, and the conductors 51 to 57 from the heat radiation member 8 to the outside, the current to be supplied to the light emitting chips 40 to 44 can be raised (heightened, increased), and accordingly, the light flux (light intensity, brightness, luminance, and light amount) of the light radiated from the light emitting chips 40 to 44 can be raised (increased).

More specifically, according to the light source unit land the vehicle light unit 100 of the exemplary embodiment 1 shown in FIG. 3A, the male terminals 910 to 930 of the power feeding members 91 to 93 are bended toward the mounting direction “D” orthogonally or substantially orthogonally with respect to and the center line direction O-O. On the other hand, according to the light source unit 1A shown in FIG. 3B, the male terminals 910 to 930 of the power feeding members 91 to 93 are disposed substantially in a straight line in the center line direction O-O. As a result, the light source unit 1 and the vehicle light unit 100 of the exemplary embodiment 1 shown in FIG. 3A can decrease the surface of the heat radiation member 8 covered with the connector portion 13 of the insulation member 7 surrounding the male terminals 910 to 930 of the power feeding members 91 to 93 compared with the light source unit 1A shown in FIG. 3B In other words, the surface of the heat radiation member 8 can be widened out of the insulation 7.

Further, according to the light source unit 1 and the vehicle light unit 100 of the exemplary embodiment 1, since the power feeding members 91 to 93 are disposed at the side of the connector portion 13 with respect to the center “O” of the light source portion 10 and the socket portion 11, a part of the insulation member 7 included in the connector portion 13 together with the male terminals 910 to 930 of the power feeding members 91 to 93 can be disposed closer to the side of the connector portion 13. As a result, according to the light source unit land the vehicle light unit 100 of the exemplary embodiment 1, since the surface (portion) “B” of the heat radiation member 8 exposed out of the insulation member 7 can be further widened (increased), the heat generated by the light emitting chips 40 to 44, the resistances RS, RT, RP, the diodes DS, DT, and the conductors 51 to 57 can be further efficiently radiated from the radiation member 8 to the outside.

Further, according to the light source unit 1 and the vehicle light unit 100 of the exemplary embodiment 1, since the connector portion 13 is placed to be, when the light source unit 1 is mounted to the vehicle light unit 100, at the lower side with respect to the center “O” of the light source portion 10 and the socket portion 11, a part of the insulation member included in the connector portion 13 is placed at the lower side therewith together with the male terminals 910 to 930 of the power feeding members 91 to 93 while the heat radiation member 8 exposed out of the insulation member 7 is placed at the upper side. As a result, the light source unit 1 and the vehicle light unit 100 of the exemplary embodiment 1 can radiate the heat generated by the light emitting chips 40 to 44, the resistances RS, RT, RP, the diodes DS, DT, and the conductors 51 to 57 further efficiently from the heat radiation member to the outside due to the convective flow of the air flowing from the lower side to the upper side.

Furthermore, according to the light source unit 1 and the vehicle light unit 100 of the exemplary embodiment 1, when the light source unit 1 is mounted to the vehicle light unit 100, since a direction of a fin-like shape of the heat radiation member 8 corresponds to or substantially corresponds to a direction in which the air flows, the heat is radiated in the direction in which the air flows along the fin-like shape of the heat radiation member 8, thereby further improving a heat-radiation effect. At this point, in the vehicle light unit 100, a rib or a space may be generally formed in at least one of a lamp housing 101 and a body due to the mount of the lamp housing 101 to the body of the vehicle. In this case, the air flows along the space in the rib. Therefore, in the case described above, the light source unit 1 and the vehicle light unit 100 of the exemplary embodiment 1 are most appropriate to improve the heat radiation effect.

Particularly, according to the light source unit land the vehicle light unit 100 of the exemplary embodiment 1, when the light source unit 1 is mounted to the vehicle light unit 100, since the direction of a fin-like shape of the heat radiation member 8 corresponds to or substantially corresponds to the vertical direction (perpendicular direction) due to the convection flow of the air flowing from the lower side to the upper side, the heat generated by the light emitting chips 40 to 44, the resistances RS, RT, RP, the diodes DS, DT, and the conductors 51 to 57 can be further efficiently radiated from the heat radiation member to the outside.

Moreover, according to the light source unit 1 and the vehicle light unit 100 of the exemplary embodiment 1, the male terminals 910 to 930 included in the connector portion 13 of the three power feeding members 91 to 93 are disposed perpendicularly or substantially perpendicularly with respect to the direction O-O for mounting the light source unit 1 to the vehicle light unit 100 and the direction “D” for mounting the connector 14 at the power source side to the connector portion 13, in other words, are disposed in one line in the direction of right to left. Thus, the dimensions in the center line direction O-O (center line direction O-O of the light source unit 1 (optical axis direction O-O), and depth direction thereof) of the light source portion 10 and the socket portion 11, in other words, the depth space can be further decreased, compared with the light source unit 1A (refer to FIG. 3B) in which the male terminals 910 to 930 included in the connector portion 13 of the three power feeding members 91 to 93 are disposed in the direction O-O for mounting the light source unit 1 to the vehicle light unit 100.

Further, according to the light source unit 1 and the vehicle light unit 100 of the exemplary embodiment 1, the lock unit 73 for locking a state of mounting the connector 14 at the power source side is provided on the surfaces other than the surface opposite (rear surface) to the vehicle light unit 100 of the connector portion 13 when the light source unit 1 is mounted to the vehicle light unit 100 (either one surface of both right and left side surfaces and a front surface). Thus, the dimensions in the center line direction O-O (center line direction O-O of the light source unit 1 (optical axis direction O-O), and depth direction thereof) of the light source portion 10 and the socket portion 11, in other words, the depth space can be further decreased, compared with the light source unit (not shown) in which the lock unit 73 is provided for locking the state of mounting the connector 14 at the power source side on the surface (light surface) of the connector portion 13 opposite to the vehicle light unit 100 when the light source unit 1 is mounted to the vehicle light unit 100.

### Exemplary Embodiment 2

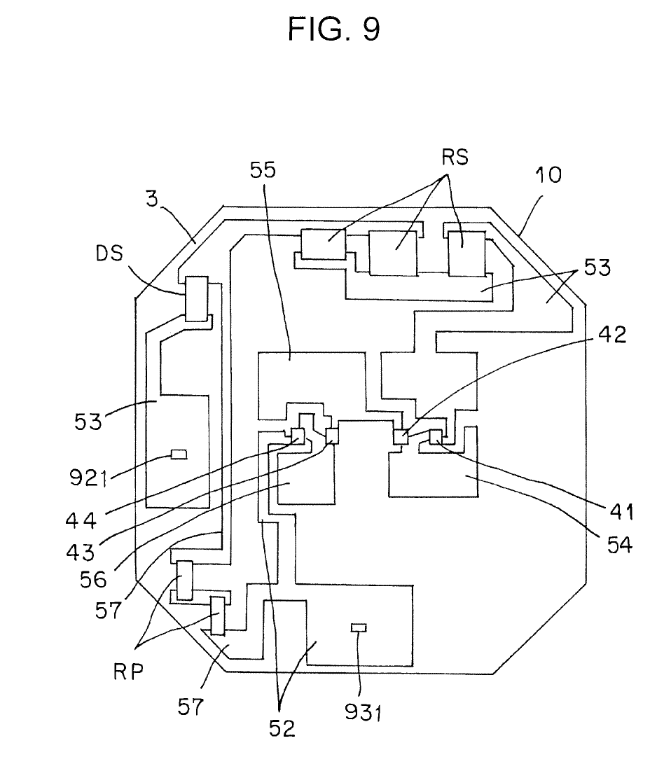

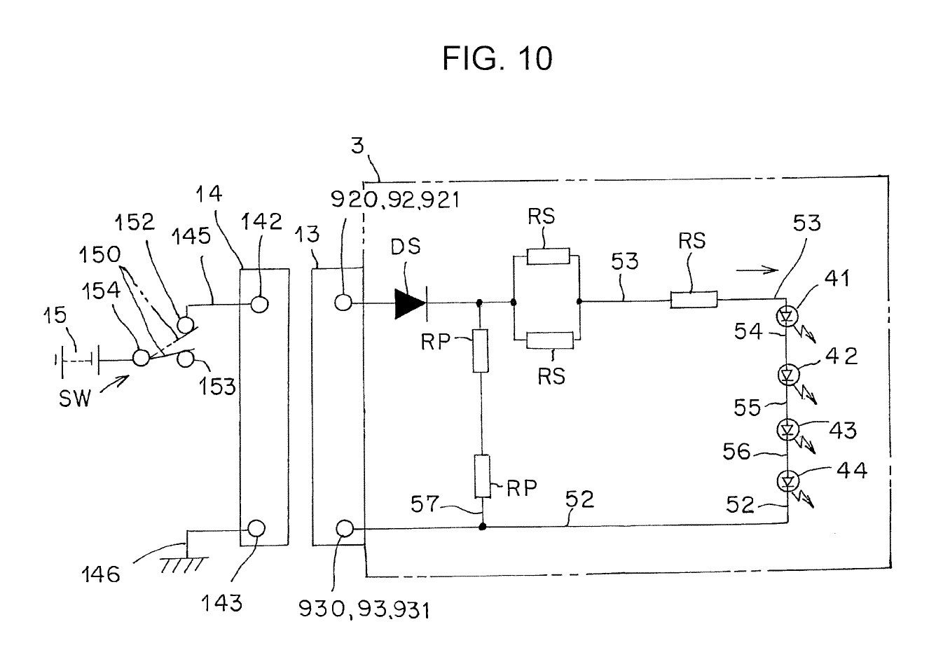

FIGS. 9, 10 show a light source unit of a semiconductor-type light source for a vehicle light unit according to a exemplary embodiment 2 of the present invention and the vehicle light unit according to the exemplary embodiment 2. In drawings, the same reference numerals indicate the same components.

The light source unit 1 and the vehicle light unit 100 according to the exemplary embodiment 1 includes a tale stop lamp having one lamp. In other words, the light source unit 1 and the vehicle light unit 100 has a tale lamp function serving as a first lamp function and a stop lamp function serving as a second lamp function with one light (one lamp, one lighting unit). That is, the light source unit 1 and the vehicle light unit 100 according to the exemplary embodiment 1 function as a multiple functional (multi-function) lamp. On the other hand, the light source unit and the vehicle light unit according to the exemplary embodiment 2 includes a low-beam lamp (headlamp for passing) including a turn signal lamp, a backup lamp, a stop lamp, a tale lamp, and a headlamp, a high-beam lamps (headlamp for running) for a headlamp, a fog lamp, a clearance lamp, a cornering lamp, and a daytime running lamp.

As shown in the layout drawing in FIG. 9 and the electric circuit drawing in FIG. 10, one light emitting chip 40 having the first lamp function, the first conductor 51, the resistance RT, the diode DT, and the first power feeding member 91 are omitted therein.

In the layout drawing in FIG. 9 and the electric circuit diagram in FIG. 10, in place of the third power feeding member 93 used as a ground, the first power feeding member 91 in he layout drawing in FIG. 9 and the electric circuit diagram in FIG. 10 may be used.

Further, the four light emitting chips 41 to 44 having the second lamp function, the third conductors 51 to 56, the resistance RS, the diode DS, and the second power feeding member 92 may be omitted in the layout drawing in FIG. 9 and the electric circuit diagram in FIG. 10. In this case, in place of the third power member 93 used as the ground, the second power feeding member 92 may be used as the ground.

Further, the one light emitting chips 40 having the first lamp function, the first conductors 51, the resistance RT, and the diode DT, or the four light emitting chips 41 to 44 having the second lamp function, the third conductors 51 to 56, the resistance RS, and the diode DS may be omitted, and the first power feeding member 91 having the first lamp or the power feeding member 92 having the second lamp function may be left as it is. Alternatively, the first power feeding member 91 having the first lamp function or only the second power feeding member 92 having the second lamp function may be omitted and the one light emitting chips 40 having the first lamp function, the first conductors 51, the resistance RT, and the diode DT, or the four light emitting chips 41 to 44 having the second lamp function, the third conductors 51 to the sixth conductor 56, the resistance RS, and the diode DS may be left as it is.

### Description of Examples Other than Exemplary Embodiments 1, 2

According to the exemplary embodiment 1, the one light emitting chip 40 serving as the light emitting chip and having the first lamp function and the four light emitting chips 41 to 44 serving as the light emitting chip and having the second lamp function are used. However, according to the present invention, two or more light emitting chips may be used as the light emitting chip having the first lamp function, and one, two, three, five or more light emitting chips may be used as the light emitting chip having the second lamp function. The number and a layout of the light emitting chips to be used as the first lamp function of the tale lamp function and those of the light emitting chips to be used as the second lamp function of the stop lamp function are not specifically limited. Further, the number and the layout of the light emitting chips to be used as a single function lamp are not specifically limited.

Furthermore, according to the exemplary embodiment 2, the four light emitting chips 41 to 44 (or, one light emitting chip 40) are used as the lamp having one lamp function. However, in the present invention, the number and the layout of the light emitting chips to be used as the lamp having the one lamp function are not specifically limited.

Moreover, the exemplary embodiment 1 is applied to the lamp having two lamp functions, which are for the tale/stop. However, the present invention can be applied to a combination lamp other than the tale/stop lamp, in other words, the lamp having two lamp functions. For example, the present invention can be applied to the combination lamp of the daytime running lamp and the low-beam lamp (headlamp for passing). More specifically, the light emitting chip having a small current supply and a small light emitting amount and the light emitting chip having a large current supply and a large light emitting amount perform the same operations as those of the light source unit having a double filaments of a main filament having the large light emitting amount and a sub filament having the small light emitting amount.

Further, according to the exemplary embodiments 1, 2, the mounting surface 34 of the board 3 is provided with a sealing member (not shown) thereon. However, according to the present invention, the five light emitting chips 40 to 44 or a bank member surrounding the four light emitting chips 41 to 44 may be provided on the mounting surface 34 of the board 3, and the sealing member may be provided in the bank member (refer to Japanese Patent Application Laid-Open No. 2010-172591). Furthermore, an optical member may be provided in the bank member (refer to Japanese Patent Application Laid-Open No. 2010-172592).

Moreover, according to the exemplary embodiments 1, 2, the board 3 may be constituted by one piece of the board. However, according to the present invention, the board divided into two may be used (refer to Japanese Patent Application Laid-Open No. 2010-186526).

Still furthermore, in the foregoing exemplary embodiments 1 and 2, light distribution is controlled by means of a cover portion 12 and a lamp lens 102. However, in the present invention, light distribution may be controlled by means of at least one of the cover portion 12 and the lamp lens 102, or alternatively, by means of any other constituent element such as a reflection surface or a lens.

Further, according the exemplary embodiments 1, 2, on the mounting surface 34 of the board 3 serving as the mount member, the light emitting chips 40 to 44, the conductors 51 to 57 serving as the wiring element, the resistances RT, RS, RP, and the diodes DT, DS are mounted. However, in the present invention, without using the board 3, via an insulation layer on the mounting surface (abutment surface 80) of the heat radiation member 8, the light emitting chips 40 to 44, the conductors 51 to 57 serving as the wiring element, the resistances RT, RS, RP, and the diodes DT, DS may be mounted. In this case, the heat radiation member 8 is used as the mount portion.

Furthermore, according to the exemplary embodiment 1, 2, as the connector 14, a standard-type connector (regular product) of a three-pin type or a two-pin type that can be mechanically, detachably, electrically, and continuously mounted to the connector portion 13 is used. However, in the present invention, as the connector, a special-order product (irregular product) fixed to a constitution of the connector portion 13 may be used.

What is claimed is:

1. A light source unit of a semiconductor-type light source for a vehicle light unit, comprising:
a light source portion and a socket portion to which the light source portion is mounted, wherein
the light source portion comprises a mount member including a mounting surface and an abutment surface, a light emitting chip of a semiconductor-type light source, a control element for controlling light emitting of the light emitting chip, a wiring element for feeding power to the light emitting chip via the control element;
the light emitting chip, the control element, and the wiring element are mounted onto the mounting surface of the mount portion;
the socket portion comprises an insulation member, a heat radiation member that includes the abutment surface to which the abutment surface of the mount member is abutted and radiates heat generated by the light source portion, and a plurality of power feeding members for feeding the power to the light source portion;
the heat radiation member and the power feeding member are incorporated mutually into the insulation member in an insulation state;
a connector portion to which a connector at a power source side mechanically, detachably, electrically, continuously mounted is provided leaning against a center of the light source portion and the socket portions;
the connector portion includes a part of the insulation member and a one-end part of the power feeding member;
at least, a portion opposite to the connector portion in the heat radiation member is exposed out of the insulation member;
a direction for mounting the light source unit to the vehicle light unit is perpendicular or substantially perpendicular with respect to the mounting surface on the mount member; and
a direction for mounting the connector at the power source side to the connector portion is perpendicular or substantially perpendicular with respect to the direction for mounting the light source unit to the vehicle light unit.

2. The light source unit of a semiconductor-type light source for a vehicle light unit according to claim 1, wherein
the power feeding member is disposed at a side of the connector portion with respect to the center of the light source portion and the socket portion.

3. The light source unit of a semiconductor-type light source for a vehicle light unit according to claim 1, wherein
the connector portion is placed to be, when the light source portion is mounted to the vehicle light unit via the mount portion, at a lower side with respect to a center of the light source portion and the socket portion.

4. The light source unit of a semiconductor-type light source for a vehicle light unit according to claim 1, wherein,
at least a part of the heat radiation member exposed out of the insulation member has a fin-like shape,
a direction of the fin-like shape of the heat radiation member corresponds to or substantially corresponds to a direction in which air flows when the light source portion is mounted to the vehicle light unit via the mount portion.

5. The light source unit of a semiconductor-type light source for a vehicle light unit according to claim 1, wherein
a one-end part included in the connector portion of a plurality of power feeding members are disposed in one line perpendicularly or substantially perpendicularly with respect to the direction for mounting the light source unit to the vehicle light unit.

6. The light source unit of a semiconductor-type light source for a vehicle light unit according to claim 1, wherein,
when the light source portion is mounted to the vehicle light unit via the mount portion, on a surface other than a surface opposite to the vehicle light unit, a lock unit for locking a state for mounting the connector at the power source side is provided.

7. A vehicle light unit including a semiconductor-type light source as a light source, comprising:
a lamp housing configured to divide a lamp room, and a lamp lens;
a light source unit of a semiconductor-type for a vehicle light unit according to claim 1 that is disposed in the lamp room.
